(19) United States
(12) Patent Application Publication
(10) Pub. No.: US 2026/0300938 A1
(43) Pub. Date: Oct. 1, 2026

(54) INFORMATION PROCESSING SYSTEM AND INFORMATION PROCESSING METHOD

(71) Applicant: TOYOTA JIDOSHA KABUSHIKI KAISHA, Toyota-shi Aichi-ken (JP)

(72) Inventor: Iwao NITTA, Nagoya-shi Aichi-ken (JP)

(73) Assignee: TOYOTA JIDOSHA KABUSHIKI KAISHA, Toyota-shi Aichi-ken (JP)

(21) Appl. No.: 19/574,557

(22) Filed: Mar. 23, 2026

(30) Foreign Application Priority Data
Mar. 31, 2025 (JP) 2025-058381

(51) Int. Cl. G06Q 10/30

(52) U.S. Cl. CPC G06Q 10/30

(57) ABSTRACT

An information processing system includes a first information processing apparatus, a second information processing apparatus, and a storage resource storing product information. The first information processing apparatus updates a value indicating use status in the product information for a target recycled product based on notifications from a terminal of a party concerned. The second information processing apparatus determines whether use status updates occurred within a predetermined time period. When a relevant recycled product has not been updated during this period, the second apparatus estimates its current use status from the last recorded value at the relevant time point, according to a given rule.

This application claims the benefit of Japanese Patent Application No. 2025-058381, filed on Mar 31, 2025, which is hereby incorporated by reference herein in its entirety.

### BACKGROUND

### Technical Field

The present disclosure relates to an information processing system and an information processing method.

### DESCRIPTION OF THE RELATED ART

A server apparatus proposed in Japanese Patent Laid-Open No. 2024-106790 includes: a storage device that stores product information related to products of companies included in a supply chain on a company basis; and a controller. The supply chain has a structure with three or more tiers. Among companies on two adjacent tiers, upstream companies and downstream companies are defined. The controller receives a permission command that includes designation of a downstream company permitted to access first product information related to upstream products of an upstream company, from the account of the upstream company. The controller receives, from the account of the downstream company, an association request that includes selection of first product information to be associated with second product information related to downstream products of the downstream company, from the first product information with the access permission by the permission command. The controller then generates association information that indicates association relationship designated by the association request, in response to the received association request.

### SUMMARY

One object of the present disclosure is to provide a technology of ensuring the traceability after products are distributed.

An information processing system according to a first aspect in the present disclosure includes a first information processing apparatus, a second information processing apparatus, and a storage resource. The first information processing apparatus includes a first controller, and is configured to be accessible to the storage resource. The second information processing apparatus includes a second controller, and is configured to be accessible to the storage resource. The storage resource stores, for each recycled product, product information that includes identification information and a value indicating a use status of a recycled product. The first controller of the first information processing apparatus is configured to execute: receiving, from a terminal of a party concerned of a target recycled product, a notification that includes the identification information on the target recycled product, and is related to the use status of the target recycled product; accessing the product information on the target recycled product in the product information stored in the storage resource using the identification information included in the received notification; and updating the value indicating the use status included in the accessed product information on the target recycled product, in accordance with the received notification. The second controller of the second information processing apparatus is configured to execute: determining, for each recycled product, whether an update of the value indicating the use status in the product information stored in the storage resource is made in a predetermined time period or not; estimating a current use status of a relevant recycled product that has not been updated in terms of the value indicating the use status in the predetermined time period, from the value indicating the use status of the relevant recycled product at a relevant time point at which the update is determined not to be made in the predetermined time period, according to a given rule, when the relevant recycled product is present among the recycled products; and outputting information related to a result of an estimation of the current use status of the relevant recycled product.

An information processing method according to a second aspect in the present disclosure is executed by a first computer and a second computer that are configured to be accessible to a storage resource that stores, for each recycled product, product information that includes identification information and a value indicating a use status of a recycled product. The information processing method includes: the first computer receiving, from a terminal of a party concerned of a target recycled product, a notification that includes the identification information on the target recycled product, and is related to the use status of the target recycled product; the first computer accessing the product information on the target recycled product in the product information stored in the storage resource using the identification information included in the received notification; and the first computer updating the value indicating the use status included in the accessed product information on the target recycled product, in accordance with the received notification, the second computer determining, for each recycled product, whether an update of the value indicating the use status in the product information stored in the storage resource is made in a predetermined time period or not; the second computer estimating a current use status of a relevant recycled product that has not been updated in terms of the value indicating the use status in the predetermined time period, from the value indicating the use status of the relevant recycled product at a relevant time point at which the update is determined not to be made in the predetermined time period, according to a given rule, when the relevant recycled product is present among the recycled products; and the second computer outputting information related to a result of an estimation of the current use status of the relevant recycled product.

According to the present disclosure, the technology of ensuring the traceability after recycled products are distributed can be provided.

### BRIEF DESCRIPTION OF THE DRAWINGS

FIG. 1 schematically illustrates an example of a scene to which the present disclosure is applied;

FIG. 2 schematically illustrates an example of a scene to which the present disclosure is applied;

FIG. 3 schematically illustrates an example of a recycled product;

FIG. 4 schematically illustrates an example of a use status after the recycled product is distributed;

FIG. 5 schematically illustrates an example of the configuration of the product information;

FIG. 6 schematically illustrates an example of a given rule;

FIG. 7 schematically illustrates an example of a hardware configuration of a first information processing apparatus;

FIG. 8 schematically illustrates an example of a hardware configuration of a second information processing apparatus;

FIG. 9 schematically illustrates an example of a software configuration of the first information processing apparatus;

FIG. 10 schematically illustrates an example of a software configuration of the second information processing apparatus;

FIG. 11 is a flowchart illustrating an example of processing procedures related to an update of the use status by the first information processing apparatus; and

FIG. 12 is a flowchart illustrating an example of processing procedures related to estimation of the current use status by the second information processing apparatus.

### DESCRIPTION OF THE EMBODIMENTS

According to the system proposed in Japanese Patent Laid-Open No. 2024-106790, the traceability of information (carbon footprint etc.) related to the process of manufacturing products, such as batteries, can be ensured. On the other hand, with the goal of achieving a sustainable society, it is desirable to increase the recycling rate of manufactured products. To improve the recycling rate, it is desirable to ensure the traceability of the use status (state) of each of the products even after the products are distributed. In the system proposed in Japanese Patent Laid-Open No. 2024-106790, the traceability in the manufacturing process before the products are distributed can be ensured, but it is difficult to ensure the traceability after the distribution.

On the other hand, an information processing system according to a first aspect in the present disclosure includes a first information processing apparatus, a second information processing apparatus, and a storage resource. The first information processing apparatus includes a first controller, and is configured to be accessible to the storage resource. The second information processing apparatus includes a second controller, and is configured to be accessible to the storage resource. The storage resource stores, for each recycled product, product information that includes identification information and a value indicating a use status of a recycled product. The first controller of the first information processing apparatus is configured to execute: receiving, from a terminal of a party concerned of a target recycled product, a notification that includes the identification information on the target recycled product, and is related to the use status of the target recycled product; accessing the product information on the target recycled product in the product information stored in the storage resource using the identification information included in the received notification; and updating the value indicating the use status included in the accessed product information on the target recycled product, in accordance with the received notification. The second controller of the second information processing apparatus is configured to execute: determining, for each recycled product, whether an update of the value indicating the use status in the product information stored in the storage resource is made in a predetermined time period or not; estimating a current use status of a relevant recycled product that has not been updated in terms of the value indicating the use status in the predetermined time period, from the value indicating the use status of the relevant recycled product at a relevant time point at which the update is determined not to be made in the predetermined time period, according to a given rule, when the relevant recycled product is present among the recycled products; and outputting information related to a result of an estimation of the current use status of the relevant recycled product.

According to the first aspect in the present disclosure, by the notification from the terminal of the party concerned, the traceability of the use status during authorized operation after distribution of the recycled products can be ensured. In addition, in some cases, the recycled products may deviate from an authorized operation route, such as being smuggled abroad or misused domestically. In case of deviation from the authorized operation route, the update of the use status may halt. Note that for example, when the recycled product is a battery mounted on a product, and the update of the use status halts on a secondhand-sale stage, the cause of the halt of the update of the use status can be estimated from the most recent use status immediately before the halt of the update to a certain extent: the cause may be a high possibility that the battery has been smuggled abroad or misused domestically in a state of being mounted on the product. That is, possible alternatives of the cause of the halt of the update of the use status can be narrowed down to a certain range depending on the most recent use status immediately before the halt of the update. According to this configuration, through use thereof, the current use status of the recycled product (relevant recycled product) after the halt of the update of the use status can be traced at a certain certainty, based on monitoring of whether the use status is updated in a predetermined time period or not. Consequently, according to this configuration, it is expected that the traceability is appropriately ensured after recycled product distribution.

Note that the implementation of the present disclosure is not limited to the information processing system described above. As another implementation of the information processing system according to the aspect described above, an aspect of the present disclosure may be at least any of an information processing apparatus, an information processing method, and a program that realize at least some of the components described above, and a storage medium that stores such a program and can be read by a machine, such as a computer. Here, the storage medium that can be read by the machine may be a non-transitory medium that accumulates information, such as the program, through an electrical, magnetic, optical, mechanical, or chemical action. Such non-transitory storage media may include storage media (CD, DVD, semiconductor memory, etc.), an auxiliary storage device, and an external storage device connected to a computer.

An information processing method according to a second aspect in the present disclosure is executed by a first computer and a second computer that are configured to be accessible to a storage resource that stores, for each recycled product, product information that includes identification information and a value indicating a use status of a recycled product. The information processing method includes: the first computer receiving, from a terminal of a party concerned of a target recycled product, a notification that includes the identification information on the target recycled product, and is related to the use status of the target recycled product; the first computer accessing the product information on the target recycled product in the product information stored in the storage resource using the identification information included in the received notification; and the first computer updating the value indicating the use status included in the accessed product information on the target recycled product, in accordance with the received notification, the second computer determining, for each recycled product, whether an update of the value indicating the use status in the product information stored in the storage resource is made in a predetermined time period or not; the second computer estimating a current use status of a relevant recycled product that has not been updated in terms of the value indicating the use status in the predetermined time period, from the value indicating the use status of the relevant recycled product at a relevant time point at which the update is determined not to be made in the predetermined time period, according to a given rule, when the relevant recycled product is present among the recycled products; and the second computer outputting information related to a result of an estimation of the current use status of the relevant recycled product.

An embodiment according to an aspect of the present disclosure is described below with reference to the drawings. Note that the present embodiment described below is only an example of the present disclosure in all respects. Various improvements and modifications may be made without departing from the scope of the present disclosure. To implement the present disclosure, specific configurations in accordance to the embodiment may be employed as appropriate. Note that data that appears in the present embodiment is described using a natural language, and more specifically, is designated by a pseudo-language, a command, a parameter, a machine language, an electric signal or the like that can be recognized by a machine, such as a computer.

### 1 Application Example

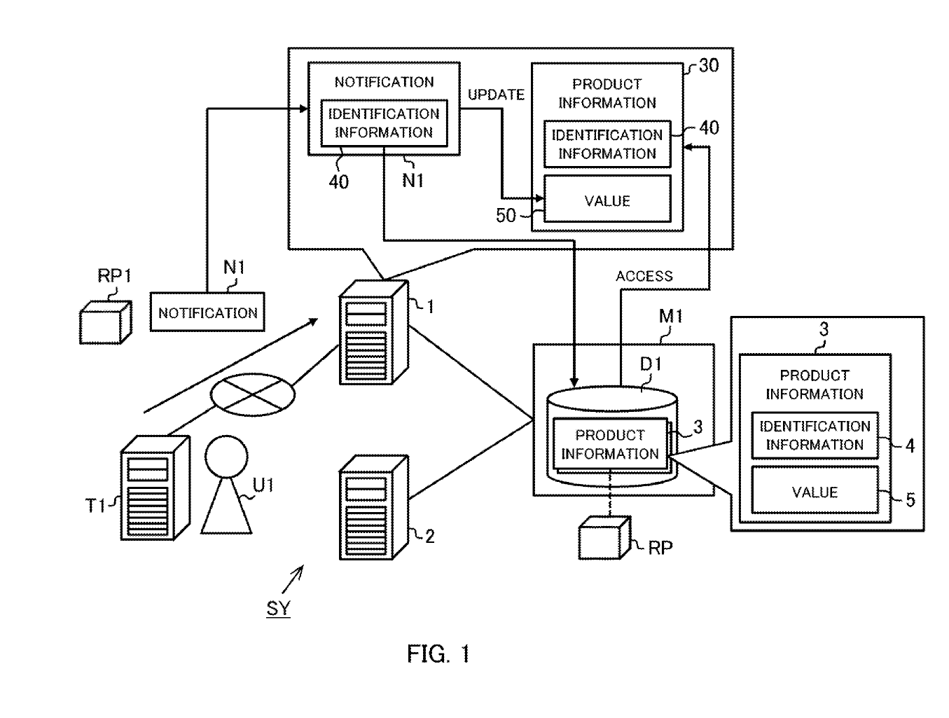

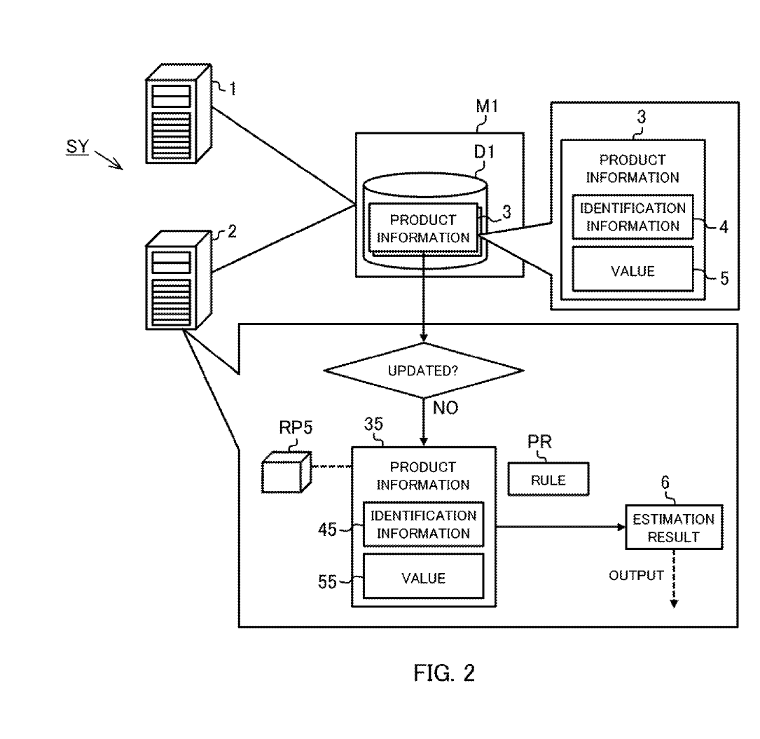

FIGS. 1 and 2 schematically illustrate an example of a scene to which the present disclosure is applied. An information processing system SY according to the present embodiment includes a first information processing apparatus 1, a second information processing apparatus 2, and a storage resource M1. The first information processing apparatus 1 and the second information processing apparatus 2 are configured to be accessible to the storage resource M1. The storage resource M1 stores, for each recycled product RP, product information 3 that includes identification information 4 and a value 5 indicating the use status of a recycled product RP.

As illustrated in FIG. 1, the first information processing apparatus 1 is one or more computers configured to update the value 5 indicating the use status included in the product information 3 in response to a notification from a terminal of a party concerned. The first information processing apparatus 1 is an example of a first computer in the present disclosure. In the present embodiment, the first information processing apparatus 1 receives a notification N1 that includes identification information 40 on a target recycled product RP1 and is related to the use status of the target recycled product RP1, from a terminal T1 of a party concerned U1 of the target recycled product RP1. The target recycled product RP1 is a recycled product RP that serves as a target of notification about the use status issued through the notification N1. The first information processing apparatus 1 accesses product information 30 on the target recycled product RP1 in the product information 3 stored in the storage resource M1, using the identification information 40 included in the received notification N1. That is, the first information processing apparatus 1 uses the identification information 40 for a query, and extracts the product information 30 on the target recycled product RP1 in the product information 3. The identification information 40 and a value 50 indicating the use status, which are included in the product information 30 on the target recycled product RP1, are the identification information 4 on and the value 5 indicating the use status of the target recycled product RP1. The first information processing apparatus 1 updates the value 50 that indicates the use status and is included in the accessed product information 30 on the target recycled product RP1 in accordance with the received notification N1.

On the other hand, as illustrated in FIG. 2, the second information processing apparatus 2 is one or more computers configured to estimate the current use status of the recycled product RP in accordance with the value 5 that indicates the use status and is included in the product information 3. The second information processing apparatus 2 is an example of the second computer. In the present embodiment, the second information processing apparatus 2 determines, for each recycled product RP, whether the update of the value 5 indicating the use status in the product information 3 stored in the storage resource M1 is made in a predetermined time period or not. When a relevant recycled product RP5 that has not been updated in terms of the value 5 (55) indicating the use status in the predetermined time period is present among the recycled products RP, the second information processing apparatus 2 estimates the current use status of the relevant recycled product RP5, from the value 55 indicating the use status of the relevant recycled product RP5 at a relevant time point at which the update is determined not to be made in the predetermined time period, according to a given rule PR. The relevant recycled product RP5 is the recycled product RP that has not been updated in terms of the value 5 indicating the use status in the predetermined time period. Identification information 45 and the value 55 indicating the use status, which are included in product information 35 on the relevant recycled product RP5, are the identification information 4 on and the value 5 indicating the use status of the relevant recycled product RP5. The value 55 indicating the use status at the relevant time point may be the value 5 indicating the latest use status that has been most recently updated and is determined not to be updated in the predetermined time period. The second information processing apparatus 2 outputs information related to a result 6 of estimation of the current use status of the relevant recycled product RP5.

In the present embodiment, according to the information processing by the first information processing apparatus 1, based on the notification N1 from the terminal T1 of the party concerned U1, the traceability of the use status during authorized operation after the distribution of the recycled product RP can be ensured. In addition, there are cases in which the recycled product deviates from the authorized operation route. In case of deviation from the authorized operation route, the update of the use status may halt. Note that as described above, the cause of the halt of the update of the use status can be estimated to a certain extent from the most recent use status immediately before the halt of the update. That is, possible alternatives of the cause of the halt of the update of the use status can be narrowed down to a certain range depending on the most recent use status immediately before the halt of the update. In the present embodiment, through use thereof, according to information processing by the second information processing apparatus 2, based on monitoring of whether the use status is updated in the predetermined time period or not, the current use status of the recycled product RP (relevant recycled product RP5) after the halt of the update of the use status can be traced at a certain certainty. Consequently, according to the present embodiment, it can be expected that the traceability is appropriately ensured after the distribution of the recycled product RP.

### Recycled Product

The type of the recycled product RP is not specifically limited, and may be selected as appropriate depending on the embodiment. The recycled product RP may be any object that is to be recycled. For example, the recycled product RP is a product that includes a valuable material. The valuable material may include, for example, PGM (platinum-group metal), rare metal or the like. The rare metal may be, for example, lithium, vanadium, manganese, cobalt, nickel, gallium, tantalum, indium, tungsten or the like. The rare metal may be rare earth metal. The rare earth metal may be, for example, cerium, neodymium, dysprosium or the like. The recycled product RP may include, for example, a catalytic converter, electronic apparatus (mobile terminal etc.), and a battery.

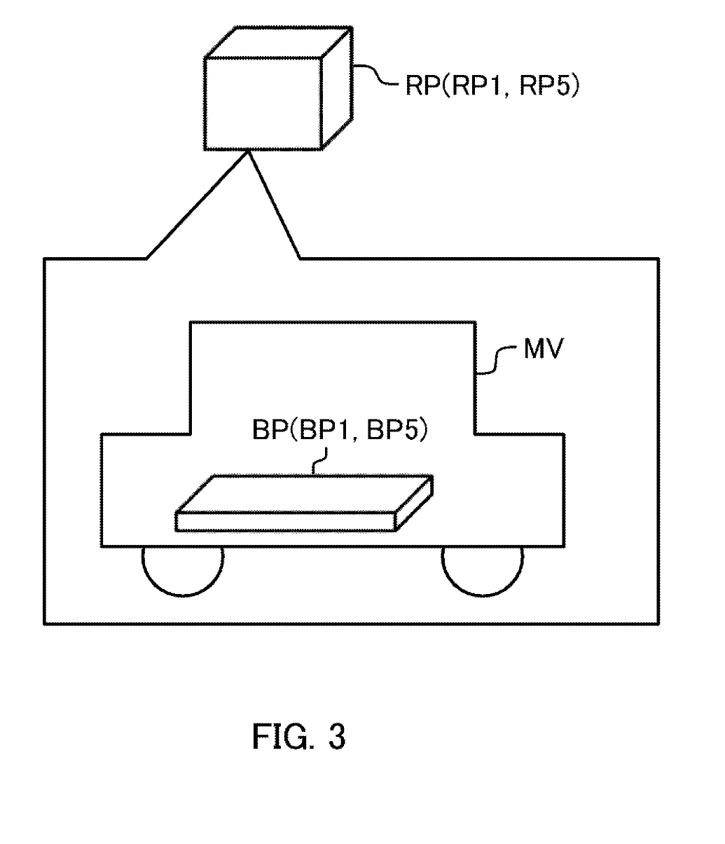

FIG. 3 schematically illustrates an example of the recycled product RP according to the present embodiment. For example, the recycled product RP may be a battery BP mounted on a product MV. In the case in which the recycled product RP is the battery BP, the target recycled product RP1 may be called a target battery BP1, and the relevant recycled product RP5 may be called a relevant battery BP5. The types of the battery BP (the target battery BP1 and the relevant battery BP5) are not specifically limited, and may be selected as appropriate depending on the embodiment. The battery BP may be, for example, a lithium-ion battery (encompassing an all-solid-state battery), a nickel hydride battery, a lead storage battery, a sodium battery, a redox flow battery, an air battery, a multivalent-ion battery, a fluorine battery or the like. The form of the battery BP is not specifically limited, and may be selected as appropriate depending on the embodiment. For example, the battery BP may be a battery pack. The battery pack may be made up of a plurality of cells (single cells) or a plurality of modules (assembled cells). Each module may be made up of a plurality of cells. The module may be called a stack. The battery pack may be achieved directly from a plurality of cells, or achieved from a plurality of cells through modules (stacks). In another example, the battery BP may be a cell (single battery) or a module (assembled cells). In an example of the present embodiment, it is expected that the traceability is appropriately ensured after the distribution of the battery BP mounted on the product MV.

Note that the type of the product MV is not specifically limited, and may be selected as appropriate depending on the embodiment. The product MV may be any of various products on which the battery (battery BP) to be recycled can be mounted. As illustrated in FIG. 3, for example, the product MV may be a vehicle. Accordingly, it can be expected that the traceability is appropriately ensured of the battery BP mounted on the vehicle after distribution. The vehicle may be an electric vehicle.

In another example, the product MV may be any product other than the vehicle. For example, the product MV may be mobility means other than vehicles, a stationary storage battery system, a mobile device, another electric product (electric machine or appliance) or the like. The mobility means other than vehicles may include, for example, bicycles, and aircraft. The aircraft may include drones. The mobile device may be a mobile terminal (a smartphone, a tablet terminal or the like). The other electric product may be a storage battery in a traffic light machine, crossing protection device, alarm, light fitting, charging station or the like. The light fitting may be an illuminating lamp, a projector (illumination in a sport facility) or the like.

### Use status

The type of the use status of the recycled product RP may be defined as appropriate depending on the embodiment. For example, the type of the use status may be defined to distinguish whether the recycled product RP is in use or not. In addition, the type of the use status may be defined to further distinguish the situation on a stage of being in use or not in use. The type of the use status may be defined without distinguishing the situation on the stage of being in use or not in use.

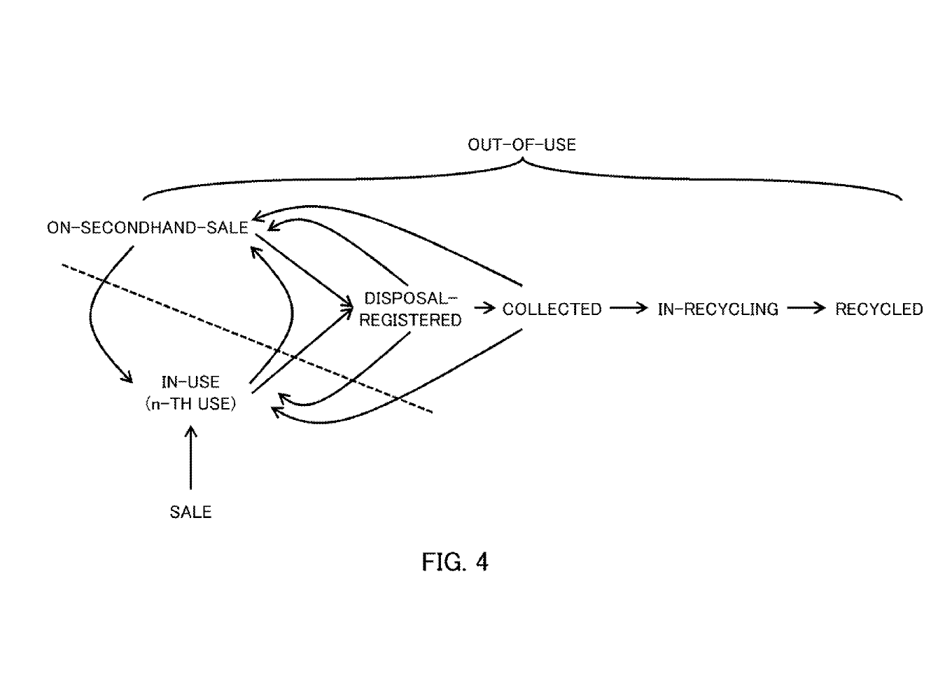

FIG. 4 schematically illustrates an example of transition of the use status after the recycled product RP according to the present embodiment is distributed. For example, the types of the use status may include in-use and out-of-use. In-use indicates a situation in which the recycled product RP is in n-th use (n is a natural number) by a user. On the in-use stage, the situations of primary use, secondary use and the like may be distinguished but is not necessarily distinguished. Out-of-use indicates a situation in which the recycled product RP is not in use. The situation on the out-of-use stage may be distinguished but is not necessarily distinguished. In the case of distinguishing the situation on the out-of-use stage, the types of the situation may be defined as appropriate depending on the embodiment. For example, out-of-use may include at least any of on-secondhand-sale, disposal-registered, collected, in-recycling, and recycled.

On-secondhand-sale may indicate a situation of being on sale by a reseller (a user, a remarketer, or the like). Disposal-registered may indicate a situation in which for recycling, the user completes using the recycled product RP, and provides the product as a collection target. Disposal-registered may include, for example, indication of an intention of disposal, and provision for disposal according to a designated method. The provision for disposal according to the designated method may include, for example, making a request from a designated business operator for disposal, and bringing to a designated periodical collection place or disposal facility. Collected may indicate a situation in which for recycling, a disposal-registered recycled product RP has been collected and is being conveyed to a recycling facility. In-recycling may indicate a situation of being subjected to a recycling process, such as recycling (detoxifying, refinement or the like) to a recycled material. Recycled may indicate a situation in which recycling to the recycled material has been completed.

The transition route of the use status may be constructed as appropriate depending on the embodiment, such as the type of the recycled product RP. For example, the recycled product RP may be sold by a seller and then used by a user (primary use). Accordingly, the use status of the recycled product RP may be started from in-use. The recycled product RP may be tested by a tester while being in-use. The recycled product RP in-use may be offered for sale by the user. Alternatively, the user may sell the recycled product RP for a reselling operator (remarketer or the like). Accordingly, the use status of the recycled product RP may transition from in-use to on-secondhand-sale (out-of-use). The recycled product RP on sale by the reseller (user, remarketer or the like) may be purchased by a user. Accordingly, the use status of the recycled product RP may return from on-secondhand-sale (out-of-use) to in-use.

The recycled product RP in-use or on-secondhand-sale may be disposal-registered by the user or the reseller. Accordingly, the use status of the recycled product RP may transition from in-use or on-secondhand-sale to disposal-registered. The disposal-registered may be verified by a tester, a certification organization, or another organization related to disposal. The disposal-registered recycled product RP may be collected by a collection trader, a recycle operator, or a processing operator. Accordingly, the use status of the recycled product RP may transition from disposal-registered to collected. Collected may be verified by the certification organization. Note that on the disposal-registered or collected stage, the recycled product RP may be provided for reuse by a reuse operator or repurposing by a repurposing operator. Accordingly, the use status of the recycled product RP may return from disposal-registered or collected to on-secondhand-sale or in-use.

The collected recycled product RP may be provided for the recycling process by the processing operator. Accordingly, the use status of the recycled product RP may transition from collected to in-recycling. By completion of the recycling process, the use status of the recycled product RP may transition from in-recycling to recycled. In-recycling and recycled may be verified by the certification organization. After completion of recycling, the recycled material is used for a new product. Accordingly, the tracing of the original state (recycled product RP) may be finished. Note that the use status and the transition route are only an example. The use status and the transition route are not limited to the example in FIG. 4, and may be changed as appropriate depending on the embodiment.

### Party Concerned

The party concerned U1 may be selected as appropriate depending on the embodiment. The party concerned U1 may be any party (a natural person or a legal entity) that can be engaged with the recycled product RP. For example, the party concerned U1 may be a seller, a user, a reseller, a tester, another organization engaged in disposal, a collection trader, a recycle operator, a reuse operator, a repurposing operator, a processing operator, a certification organization (certification authority) or the like. The seller may be an entity that sells the recycled product RP. The seller may be a manufacturer (producer), or a selling operator (dealer or the like). In the case in which the recycled product RP is the battery BP mounted on a vehicle, the seller may include a vehicle manufacturer, and a dealer. The user may include an end user, and a utilization operator. The reseller may include a user, a reselling operator (remarketer or the like). The tester may be an entity that tests the recycled product RP. In the case in which the recycled product RP is the battery BP mounted on a vehicle, the tester may be a vehicle inspection operator or the like. The other organization engaged in disposal may be an organization that serves as an agency for the producer responsibility, another non-profit organization or the like. The collection trader may be a business operator that collects the disposal-registered recycled product RP. The processing operator may be a detoxifying operator, or a business operator that performs recycling, such as a refining operator. The certification organization may be, for example, a third-party organization that certificates disposal, collection, recycling and the like. The certification organization may be called a certification authority.

The notification N1 for notification of the use status of the target may be transmitted by any party concerned engaged with the use status of the target. The use status of the target may be appropriately identified by the notification N1 from the party concerned. For example, "in-use" may be identified by the notification N1 from the seller, the user, the tester, the reuse operator, or the repurposing operator. The seller may transmit the notification N1 for reporting "in-use" while being on sale. During use of the recycled product RP, the user may periodically transmit the notification N1 for reporting "in-use". Upon testing of the recycled product RP in use, the tester may transmit the notification N1 for reporting "in-use". The reuse operator may transmit the notification N1 for reporting "in-use" in the case of reuse. The repurposing operator may transmit the notification N1 for reporting "in-use" in the case of repurposing.

Note that reuse may be use of at least part of the recycled product RP for a new product. Repurposing may be use of the recycled product RP as it is for a new product. For example, a new product obtained by reuse or repurposing may be continuously treated as the recycled product RP. When a new product is obtained from a plurality of recycled products RP, the new product may be treated as a plurality of recycled products RP. For example, a new product obtained by reuse or repurposing may be treated as a new recycled product RP. The product information 3 on the original recycled product RP may be continuously used as the product information 3 on the new product. The product information 3 on the new product may be newly created. The newly created product information 3 may be associated with the product information 3 on the original recycled product RP as appropriate. Accordingly, the product information 3 on the original recycled product RP may be managed along with the product information 3 on the new product.

For example, "on-secondhand-sale" may be identified by the notification N1 from the reseller, the reuse operator, or the repurposing operator. When selling the recycled product RP, the reseller may transmit the notification N1 for reporting "on-secondhand-sale". When providing the recycled product RP for secondhand sale through reusing, the reuse operator may transmit the notification N1 for reporting "on-secondhand-sale". When providing the recycled product RP for secondhand sale through repurposing, the repurposing operator may transmit the notification N1 for reporting "on-secondhand-sale".

For example, "disposal-registered" may be identified by the notification N1 from the user, the reseller, the tester, the certification organization, or another organization engaged in disposal. The user or the reseller may transmit the notification N1 for reporting "disposal-registered" in the disposal-registered case. The tester or another organization engaged in disposal may transmit the notification N1 for reporting "disposal-registered" in the case of engagement with the disposal registration of the recycled product RP. The certification organization may transmit the notification N1 for reporting "disposal-registered" in the case of certifying the disposal registration of the recycled product RP.

For example, "collected" may be identified by the notification N1 from the collection trader, the recycle operator, the processing operator, or the certification organization. The collection trader, the recycle operator, or the processing operator may transmit the notification N1 for reporting "collected" in the case of engagement with the recycled product RP. The certification organization may transmit the notification N1 for reporting "collected" in the case of certifying the collection of the recycled product RP.

For example, "in-recycling" or "recycled" may be identified by the notification N1 from the processing operator or the certification organization. The processing operator may transmit the notification N1 for reporting "in-recycling" in the case of providing the recycled product RP for recycling or in response to the start of the recycling process. The processing operator may transmit the notification N1 for reporting "recycled" in response to the completion of the recycling of the recycled product RP. The certification organization may transmit the notification N1 for reporting "in-recycling" when certifying the provision of the recycled product RP for recycling. The certification organization may transmit the notification N1 for reporting "recycled" in the case of certifying the completion of recycling the recycled product RP. Note that the correspondence relationship between each party concerned U1 and the use status to be reported described above is only an example. The correspondence relationship between each party concerned U1 and the use status to be reported is not limited to the example described above, and may be changed as appropriate depending on the embodiment.

### Terminal

The type of the terminal T1 is not specifically limited, and may be selected as appropriate depending on the embodiment. For example, in the case in which the recycled product RP is a computer, the terminal T1 may be the recycled product RP. That is, the recycled product RP may operate as the terminal T1. For example, in the cases in which the recycled product RP is engaged with a computer, such as the case in which the recycled product RP includes a computer and the case in which the recycled product RP is mounted on a product including a computer, the terminal T1 may be a computer engaged with the recycled product RP. For example, in the case in which the recycled product RP is the battery BP mounted on a vehicle, and the vehicle includes a vehicle-mounted device (computer), the terminal T1 may include the vehicle-mounted device. For example, the terminal T1 may be a computer other than the recycled product RP. For example, the terminal T1 may be a computer that is not related to the recycled product RP. The terminal T1 may be, for example, an embedded computer, a general-purpose personal computer (PC), a mobile terminal or the like. The general-purpose PC may be a desktop PC, a notebook PC or the like. The mobile terminal may be a user terminal, such as a smartphone or a tablet terminal.

### Notification

The notification N1 may be transmitted at any time. For example, the terminal T1 may manually transmit the notification N1 by an operation by the party concerned U1. In another example, the terminal T1 may automatically (autonomously) transmit the notification N1. When the notification N1 is generated, the identification information 40 and the use status to be reported may be obtained by any method. For example, the identification information 40 and the use status may be manually obtained by an input by the party concerned U1. The input by the party concerned U1 may be performed by any method, such as in input in a limited format (limitation to an input in a numerical value format or the like), an input in a free format, or selection from among one or more candidates stored in the terminal T1. In another example, at least any of the identification information 40 and the use status may be at least partially automatically obtained by any method, such as making a query to the recycled product RP, or access to the stored information (identification information, or information indicating the use status).

As long as the first information processing apparatus 1 can be notified of the use status, the configuration of the notification N1 related to the use status is not specifically limited, and may be defined as appropriate depending on the embodiment. For example, the notification N1 may include a value indicating the use status as a notification along with the identification information 40. Accordingly, the notification N1 may be configured to directly indicate the use status of the target recycled product RP1 that is identified by the identification information 40. The value indicating the use status as a notification is a value (value 50) that indicates the use status and has already been updated by the first information processing apparatus 1. The first information processing apparatus 1 can update the value 50 indicating the use status by replacing the value 50 that indicates the use status and is included in the product information 30 extracted based on the identification information 40, with a value included in the notification N1. In another example, the notification N1 may include, along with the identification information 40, information (input information or the like in a free format) configured to indicate the use status as a notification in a format other than that of the value indicating the use status. Accordingly, the notification N1 may be configured to indirectly indicate the use status of the target recycled product RP1. The first information processing apparatus 1 may indicate the value indicating the updated use status from information included in the notification N1 by any method, such as a rule-based one. The first information processing apparatus 1 can update the value 50 indicating the use status by replacing the value 50 that indicates the use status and is included in the product information 30, with an identified value. Note that if the past history of the use status is not retained, the update (replacement) may be overwriting. If the past history of the use status is retained, the update (replacement) may be new registration. The original value may be appropriately held in the product information 30 (product information 3) or the like.

### Product Information

In the storage resource M1, the product information 3 may be held in any method. For example, the storage resource M1 may include a database D1. The product information 3 may be stored in the database D1, thus being stored in the storage resource M1. The data format of the database D1 is not specifically limited, and may be selected as appropriate depending on the embodiment. For example, as the data format of the database D1 (product information 3), any format such as a relational database or a blockchain platform may be employed.

As long as the identification information 4 and the value 5 indicating the use status are included, the configuration of the product information 3 is not necessarily limited, and may be defined as appropriate depending on the embodiment. The product information 3 may include the identification information 4 and the value 5 indicating the use status. The product information 3 may further include any type of information related to the recycled product RP other than the identification information 4 and the value 5 indicating the use status.

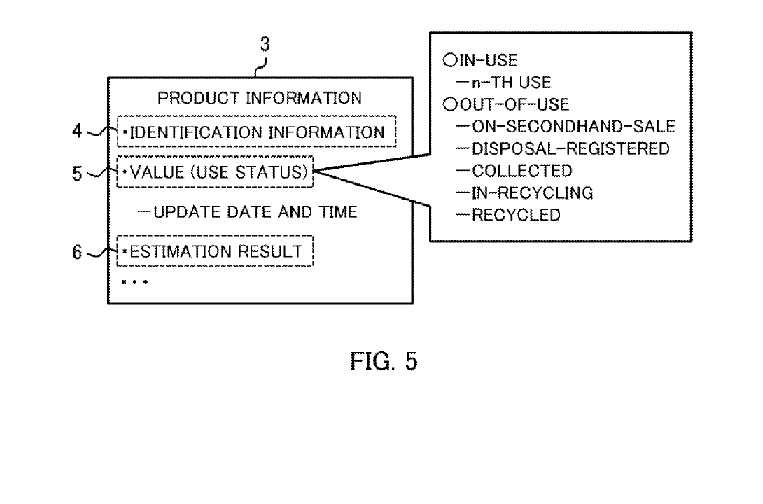

FIG. 5 schematically illustrates an example of the configuration of the product information 3 (30, 35) according to the present embodiment. For example, the product information 3 (30, 35) may include fields that store the identification information 4 (40, 45), the value 5 (50, 55) indicating the use status, and the result 6 that is an estimate of the current use status. The product information 3 (30, 35) may be called product data or the like.

As long as the corresponding recycled product RP can be identified, the format of the identification information 4 (40, 45) is not specifically limited, and may be selected as appropriate depending on the embodiment. A publicly known format, such as BIN (Battery Identification Number), UUID (Universally Unique Identifier), IMEI (International Mobile Equipment Identity), or another production number (serial number), may be employed as the identification information 4 (40, 45). The identification information 4 (40, 45) may be appropriately generated when the corresponding recycled product RP is manufactured (numbering or the like). A publicly known allocating method, such as the BIN numbering method, the UUID numbering method, or the IMEI numbering method, may be employed to generate the identification information 4 (40, 45).

As long as the use status can be identified, the data format of the value 5 (50, 55) is not specifically limited, and may be selected as appropriate depending on the embodiment. As described above, for example, the types of the use status include in-use and out-of-use. On the in-use stage, the situations of primary use, secondary use and the like may be distinguished but is not necessarily distinguished. The situation on the out-of-use stage may be distinguished but is not necessarily distinguished. For example, the types of the out-of-use may include at least any of on-secondhand-sale, disposal-registered, collected, in-recycling, and recycled.

The update date and time may be held in association with the value 5 (50, 55) indicating the use status. The product information 3 (30, 35) may further include a field for storing the update date and time. The update date and time may indicate a date and time of updating the value 5 (50, 55) indicating the use status. That is, the update date and time field may store the date and time at which the value 5 (50, 55) indicating the latest use status is stored in the use status field (the date and time of updating the use status field). As long as it can be determined whether the update has been made in the predetermined time period or not, the time unit and format of the update date and time are not specifically limited, and may be selected as appropriate depending on the embodiment. There may be an acceptable error between the update date and time stored in the field, and the actually updated date and time.

For example, in the product information 3, the value 5 (50, 55) indicating a past use status may be maintained as a past history. That is, the value 5 (50, 55) indicating the use status may be updated by new registration. The use status field may be configured to be capable of storing a plurality of values 5 (50, 55). Alternatively, the product information 3 may separately include a field for storing the value 5 (50, 55) indicating the past use status. The past history may be automatically removed in accordance with satisfaction of a predetermined condition (e.g., a lapse of a certain time period, registration of the number of items exceeding a threshold or the like). The past history may be manually removed by an operator. In another example, the value 5 (50, 55) indicating the past use status may be removed when the update is made. That is, the value 5 (50, 55) indicating the use status may be updated by overwriting.

The result 6 as an estimate of the current use status may be written by any computer, such as the second information processing apparatus 2. As long as the estimated current use status can be identified, the data format of the result 6 is not specifically limited, and may be selected as appropriate depending on the embodiment. In the case in which the estimated result 6 of the current use status is not written in the product information 3 (30, 35), the estimation result field for storing the result 6 may be omitted.

The product information 3 may further include one or more fields for storing information related to the recycled product RP other than that described above. For example, the product information 3 may further include a field for storing owner information. The owner information may be appropriately configured to indicate the owner (an individual, a legal entity or the like) of the corresponding recycled product RP. For example, the product information 3 may further include a field for storing the production date and time of the corresponding recycled product RP.

For example, in the case in which a new recycled product RP is obtained through reuse or repurposing, new product information 3 may be created for the obtained new recycled product RP. In this case, the product information 3 may further include a field for storing at least any of association of the new recycled product RP with the original recycled product RP, and association of the original recycled product RP with the new recycled product RP. For example, the identification information 4 on the original recycled product RP may be stored in the product information 3 on the new recycled product RP. Accordingly, the association of the new recycled product RP with the original recycled product RP can be managed. The identification information 4 on the new recycled product RP may be stored in the product information 3 on the original recycled product RP. Accordingly, the association of the original recycled product RP with the new recycled product RP can be monitored.

For example, in the case in which the recycled product RP is the battery BP, the product information 3 may further include any type of information related to the corresponding battery BP. For example, the product information 3 may further include a field for storing information, such as performance/durability data, composition data, model data, diagnosis/test data, battery state data, incident data, and collection/storage information. The performance/durability data may include the minimum operation voltage (minimum voltage), nominal voltage, maximum voltage (maximum service voltage), power capacity, predicted life, expected life, rated capacity, capacity fade, power, power fade, internal resistance, increase in internal resistance, round-trip efficiency of energy, and reduction rate of round-trip efficiency. The composition data may be appropriately configured to indicate the composition of the battery BP. The composition data may include material information, such as the use status (amount of use, use ratio, etc.) of the recycled material. The model data may include disassembly information (exploded view, disassembly procedures, amount of cells, layout, etc.), component numbers, and component supplier information. The diagnosis/test data may include data collected by a diagnostic device, a visual test result, an odor test result, evidence of diagnosis/test result, and the grade of the battery BP determined based on the diagnosis/test result. The battery state data may include SoH (State of Health), SoCE (State of Certified Energy), SoC(State of Charge), and SoS (State of Safety). The incident data may be appropriately configured to indicate an incident occurring in the battery BP (overcharge, overcurrent, overheat and the like). The collection/storage information may include the storage days, storage place, temperature, and a voltage during storage. The battery BP may be stored according to any method. In the case of being mounted on the product MV (vehicle or the like), the battery BP may be detached from the product MV and then stored, or stored in a state of being mounted on the product MV. In the case in which the recycled product RP is the battery BP, the product information 3 may be called another name, such as battery information (battery data), or battery passport.

### Given Rule

A given rule PR defines the correspondence relationship between the use status at the relevant time point and the result 6 that is an estimate of the current use status. The given rule PR may be appropriately defined depending on the embodiment that includes the type of recycled product RP, and the use status to which the recycled product RP can transition. The given rule PR may be defined based on the result of surveying the transition route of the recycled product RP.

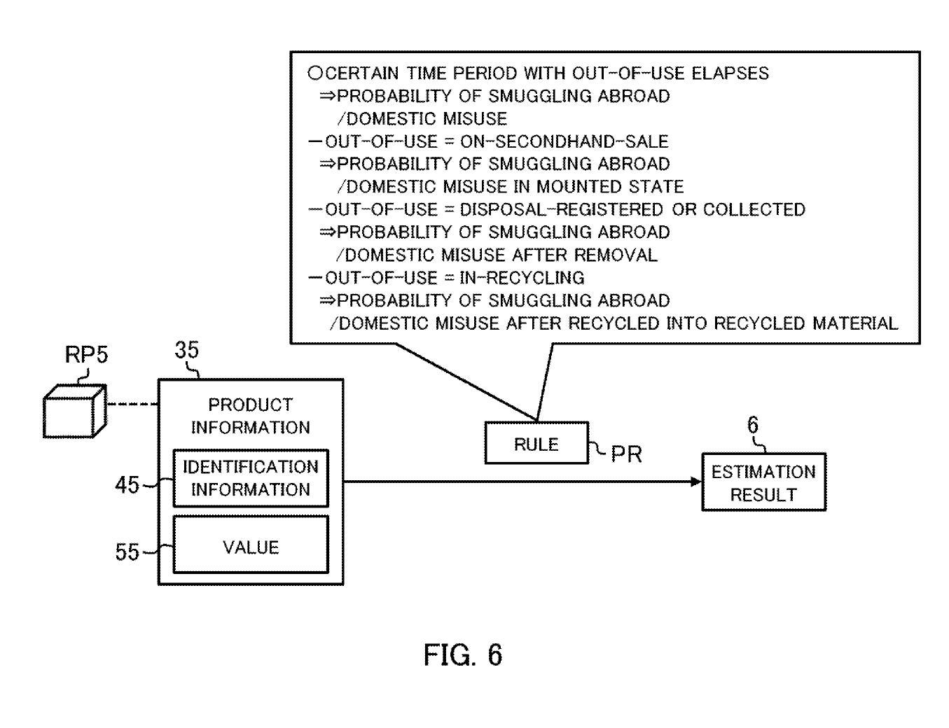

FIG. 6 schematically illustrates an example of the given rule PR according to the present embodiment. For example, the types of the use status may include in-use and out-of-use. The estimation of the current use status of the relevant recycled product RP5 may include estimating that there is a probability that the relevant recycled product RP5 has been smuggled abroad or misused domestically, as the current use status, if the value 55 indicating the use status of the relevant recycled product RP5 at the relevant time point is out-of-use. That is, the given rule PR may be defined so as to estimate smuggling abroad or domestic misuse, in accordance with a fact that the delay of update for a predetermined time period in the out-of-use state. The misuse may include unauthorized disposal and the like. The recycled product RP may deviate from an authorized operation route by being smuggled abroad or misused domestically in the out-of-use stage. As a result, the update of the use status is possibly delayed. According to an example in the present embodiment, through use of this, the possibility of being smuggled abroad or misused domestically in the out-of-use stage can be traced.

Note that in the case of distinguishing the situation in the out-of-use stage, the second information processing apparatus 2 may further estimate the state of being smuggled abroad or misused depending on the situation to be distinguished.

For example, the recycled product RP (relevant recycled product RP5) may be the battery BP (relevant battery BP5) mounted on the product MV. The out-of-use may include on-secondhand-sale. In accordance with this, the estimation of the current use status of the relevant recycled product RP5 may include estimating that there is a probability that the relevant battery BP5 has been smuggled abroad or misused domestically in the state of being mounted on the product MV, as the current use status, if the value 55 indicating the use status of the relevant battery BP5 at the relevant time point is on-secondhand-sale. That is, the given rule PR may be defined so as to estimate smuggling abroad or domestic misuse in the state of being mounted on the product MV, in accordance with a fact that the delay of update for the predetermined time period in the state of being on-secondhand-sale. The product MV may deviate from the authorized operation route by being smuggled abroad or misused domestically in the state in which the battery BP (relevant battery BP5) is mounted. As a result, the update of the use status is possibly delayed. According to an example of the present embodiment, through use of this, the possibility of smuggling abroad or domestic misuse of the product MV on which the battery BP (relevant battery BP5) is mounted in the stage of being on-secondhand-sale can be traced.

For example, the recycled product RP (relevant recycled product RP5) may be the battery BP (relevant battery BP5) mounted on the product MV. The out-of-use may include disposal-registered or collected. In accordance with this, the estimation of the current use status of the relevant recycled product RP5 may include estimating that there is a probability that the relevant battery BP5 has been smuggled abroad or misused domestically after removal from the product MV, as the current use status, if the value 55 indicating the use status of the relevant battery BP5 at the relevant time point is disposal-registered or collected. That is, the given rule PR may be defined so as to estimate smuggling abroad or domestic misuse after removal from the product MV, in accordance with a fact that the update is delayed for the predetermined time period in the disposal-registered or collected state. The battery BP (relevant battery BP5) may deviate from the authorized operation route by being smuggled abroad or misused domestically after removal from the product MV in the disposal-registered or collected stage. As a result, the update of the use status is possibly delayed. According to an example of the present embodiment, through use of this, the possibility that the battery BP (relevant battery BP5) after removal from the product MV is smuggled abroad or misused domestically in the disposal-registered or collected stage can be traced.

For example, out-of-use may include in-recycling. In accordance with this, the estimation of the current use status of the relevant recycled product RP5 may include estimating that there is a probability that the relevant recycled product RP5 has been recycled into a recycled material and then smuggled abroad or misused domestically, as the current use status, if the value 55 indicating the use status of the relevant recycled product RP5 at the relevant time point is in-recycling. That is, the given rule PR may be defined so as to estimate smuggling abroad or domestic misuse after having been recycled into the recycled material, in accordance with a fact that the update is delayed for the predetermined time period in the in-recycling situation. The recycled product RP (relevant recycled product RP5) may deviate from the authorized operation route by being smuggled abroad or misused domestically after having been recycled into the recycled material in the in-recycling stage. As a result, the update of the use status is possibly delayed. According to an example in the present embodiment, through use of this, the possibility of being smuggled abroad or misused domestically in the in-recycling stage can be traced.

The recycled material may be selected as appropriate depending on the embodiment, such as the type of the recycled product RP. For example, the recycled product RP (relevant recycled product RP5) may be the battery BP (relevant battery BP5) mounted on the product MV. In accordance with this, the recycled material may be black mass. According to an example in the present embodiment, the possibility that black mass is smuggled abroad or misused domestically in the in-recycling stage can be traced.

Note that the predetermined time period may be constant irrespective of the type (value 5) of the use status, and may vary at least partially depending on the type (value 5) of the use status. The determination of whether the value 5 indicating the use status has been updated in the predetermined time period or not may be collectively executed for the entire product information 3, and may be executed at different timing for at least part of the product information 3. The execution timing of the determination process for the product information 3 on each recycled product RP may be defined as appropriate depending on the embodiment.

The given rule PR may be defined to evaluate the time period without any update in a gradual manner. That is, the predetermined time period may be defined in a gradual manner. For example, the given rule PR may be defined such that the longer the time period without any update is, the higher the estimated certainty of the current use status is. For example, the predetermined time period may include a first predetermined time period and a second predetermined time period. The second predetermined time period may be defined to be longer than the first predetermined time period. In the case of employing the form of estimating smuggling abroad or domestic misuse from the out-of-use status described above, the second information processing apparatus 2 can estimate that there is a probability that the relevant recycled product RP5 has been smuggled abroad or misused domestically if the elapsed time period since the update of the value 5 (55) indicating the use status exceeds the first predetermined time period but does not exceed the second predetermined time period. Furthermore, if the elapsed time period since the update of the value 5 (55) indicating the use status exceeds both the first predetermined time period and the second predetermined time period, the second information processing apparatus 2 may estimate that there is a high probability that the relevant recycled product RP5 has been smuggled abroad or misused domestically.

If the product information 3 includes the past history of the value 5 indicating the use status, the transition process of the recycled product RP can be identified from the value 5 indicating the latest and past use statuses. According to the transition process, the use history of the recycled product RP can be grasped. Accordingly, there is a possibility that the current use status can be more accurately estimated. For example, the given rule PR may be defined to estimate the current use status, based on the value 5 (55) indicating the past use status along with the value 5 (55) indicating the latest use status.

When the current use status is estimated, the given rule PR may be appropriately referred to by the second information processing apparatus 2. The given rule PR may be embedded in a program (a program 82 described later), or be held as separate data. The given rule PR may be held in the storage resource of the second information processing apparatus 2, or be held in an external storage resource to which the second information processing apparatus 2 is accessible.

### System Configuration

For example, as illustrated in FIGS. 1 and 2, the first information processing apparatus 1 and the second information processing apparatus 2 may be computers that are separated from each other. However, the configuration of the information processing system SY according to the present embodiment is not necessarily limited to such an example, and may be changed as appropriate depending on the embodiment. In another example, the first information processing apparatus 1 and the second information processing apparatus 2 may be configured as an integrated computer. That is, an information processing apparatus made up of one or more computers may operate as the first information processing apparatus 1 and the second information processing apparatus 2. The storage resource M1 may be equipped in at least one of the first information processing apparatus 1 and the second information processing apparatus 2. The storage resource M1 may be equipped outside of the first information processing apparatus 1 and the second information processing apparatus 2. In the case in which the first information processing apparatus 1 and the second information processing apparatus 2 are made up of the same information processing apparatus (integrated computer), and the storage resource M1 is equipped in the information processing apparatus, the information processing apparatus may be an example of the information processing system SY.

For example, the first information processing apparatus 1 and the terminal T1 may be coupled to each other via a network. In the case in which the storage resource M1 is equipped outside of the first information processing apparatus 1, the first information processing apparatus 1 may be coupled to the storage resource M1 via the network or coupled directly thereto. In the case in which the storage resource M1 is equipped outside of the second information processing apparatus 2, the second information processing apparatus 2 may be coupled to the storage resource M1 via the network or coupled directly thereto. The type of the network may be freely selected. The type of the network may be appropriately selected from among, for example, the Internet, a wireless communication network, a mobile communication network, a phone network, a dedicated network and the like. Note that the method of exchanging data between the apparatuses is not necessarily limited to such an example, and may be changed as appropriate depending on the embodiment.

### 2 Configuration Example

### Hardware Configuration of First Information Processing Apparatus

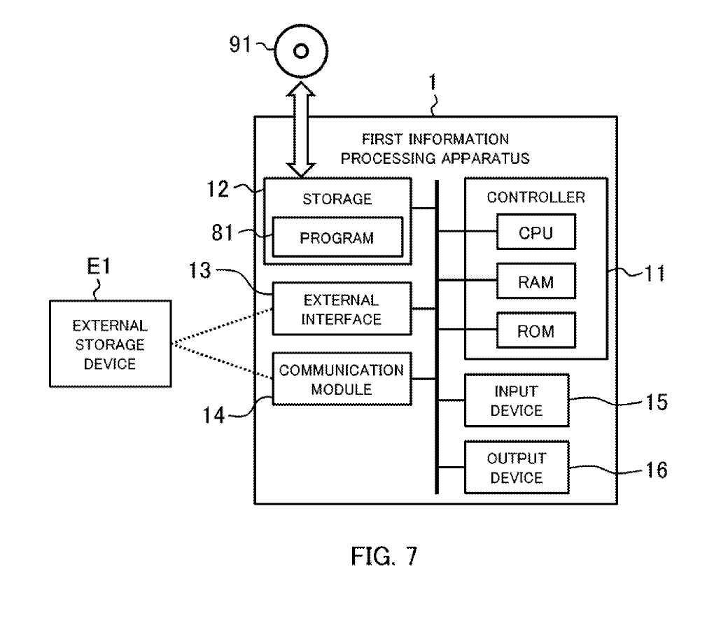

FIG. 7 schematically illustrates an example of the hardware configuration of the first information processing apparatus 1 according to the present embodiment. For example, the first information processing apparatus 1 may be configured as a computer that includes a controller 11, a storage 12, an external interface 13, a communication module 14, an input device 15, and an output device 16, which are electrically coupled to each other.

The controller 11 is configured to execute information processing, based on programs and various types of data. The controller 11 (CPU) is an example of the first controller in the present disclosure. For example, the controller 11 may include a CPU (Central Processing Unit) as a hardware processor, a RAM (Random Access Memory), and a ROM (Read Only Memory). The controller 11 (CPU) is an example of a processor resource of the first information processing apparatus 1.

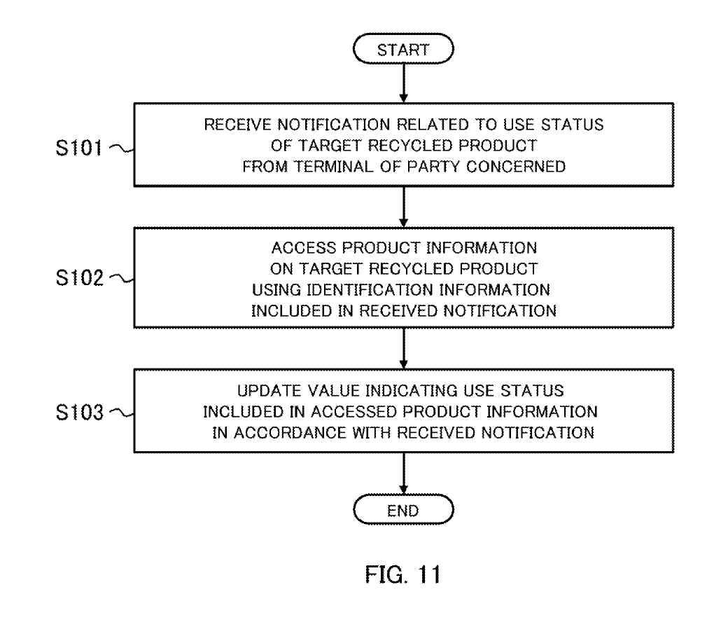

The storage 12 is configured to hold any type of data. Each of the storage 12, the RAM, and the ROM is an example of the storage resource of the first information processing apparatus 1. For example, the storage 12 may include a hard disk drive, a solid-state drive, and a semiconductor memory. For example, the storage 12 may store various types of information, such as a program 81. The program 81 is a program for causing the first information processing apparatus 1 to execute information processing (FIG. 11 described later) related to the update of the use status of the recycled product RP. The program 81 includes a series of instructions of the information processing.

For example, the program 81 may be stored in a storage medium 91 instead of the storage 12 or along with the storage 12. The storage medium 91 is configured to accumulate various types of information (stored programs and the like) through an electrical, magnetic, optical, mechanical, or chemical action such that a machine, such as a computer, can read the information. Each of the storage 12 and the storage medium 91 is an example of a non-transitory storage medium. The first information processing apparatus 1 may obtain the program 81 from the storage medium 91. The storage medium 91 may be a disk-shaped storage medium (CD, DVD, etc.), a storage medium, such as a semiconductor memory (flash memory etc.), other than the disk-shaped one. Any drive device may be used to read information stored in the storage medium 91. The type of the drive device may be selected depending on the storage medium 91. The drive device may be coupled to the first information processing apparatus 1 by any method. The storage medium 91 may include an external storage device that can be coupled to the first information processing apparatus 1.

The external interface 13 is configured to be coupled to an external device in a wired or wireless manner. The external interface 13 may be, for example, a USB (Universal Serial Bus) port, a dedicated port or the like. The types and number of external interfaces 13 may be appropriately defined depending on the embodiment. The first information processing apparatus 1 may execute data communication with another computer (terminal T1 or the like) via the external interface 13.

The communication module 14 is configured to perform wired or wireless communication via the network. The communication module 14 may be made up of, for example, a wired LAN (Local Area Network) module, wireless LAN module or the like. The standard of the network is not specifically limited, and may be selected as appropriate depending on the embodiment. The first information processing apparatus 1 may execute data communication with another computer (terminal T1 etc.) via the communication module 14.

For example, the first information processing apparatus 1 may be coupled to the external storage device E1 via the external interface 13 or the communication module 14. The external storage device E1 may include a storage device of another computer, and an NAS (Network Attached Storage). In the case in which the second information processing apparatus 2 may be made up of a computer different from the first information processing apparatus 1, the external storage device E1 may include the storage resource (a storage 22 described later or the like) of the second information processing apparatus 2. The storage resource M1 may be made up of at least one of the storage 12 and the external storage device E1. For example, in the case in which the storage resource M1 is made up of the storage 12, the controller 11 of the first information processing apparatus 1 may be configured to be accessible to the storage resource M1 by being coupled to the storage 12 with a bus. In the case in which the storage resource M1 is made up of the external storage device E1, the controller 11 of the first information processing apparatus 1 may be configured to be accessible to the storage resource M1 using the external interface 13 or the communication module 14.

The input device 15 is configured to accept input of information. The input device 15 may be made up of, for example, a mouse, a keyboard, a touch panel, a touch pad, an operation piece, a microphone, an imaging device, etc. The output device 16 is configured to output information. The output device 16 may be made up of, for example, a display, a speaker, etc. The first information processing apparatus 1 may be operated using the input device 15 and the output device 16. The input device 15 and the output device 16 may be directly coupled to the first information processing apparatus 1, or indirectly coupled thereto via at least any of the external interface 13 or the communication module 14. The input device 15 and the output device 16 may be at least partially integrally configured with a touch panel display or the like.

Note that as for the specific hardware configuration of the first information processing apparatus 1, configuration elements may be omitted, replaced, and added as appropriate depending on the embodiment. For example, the controller 11 may include a plurality of hardware processors. The hardware processor may be made up of a microprocessor, an FPGA (Field-Programmable Gate Array), a DSP (Digital Signal Processor), an ECU (Electronic Control Unit), a GPU (Graphics Processing Unit), an ASIC (Application Specific Integrated Circuit), etc. At least one or some of the external interface 13, the communication module 14, the input device 15, and the output device 16 may be omitted. The program 81 may be stored in an external storage device, such as an NAS. The external storage device is also an example of a non-transitory storage medium. The first information processing apparatus 1 may be made up of a plurality of computers. In this case, the hardware configurations of the computers may be the same as or different from each other. The first information processing apparatus 1 may be not only a computer designed for a service to be provided in a dedicated manner, but also a general-purpose server apparatus, a general-purpose PC or the like.

### Hardware Configuration of Second Information Processing Apparatus

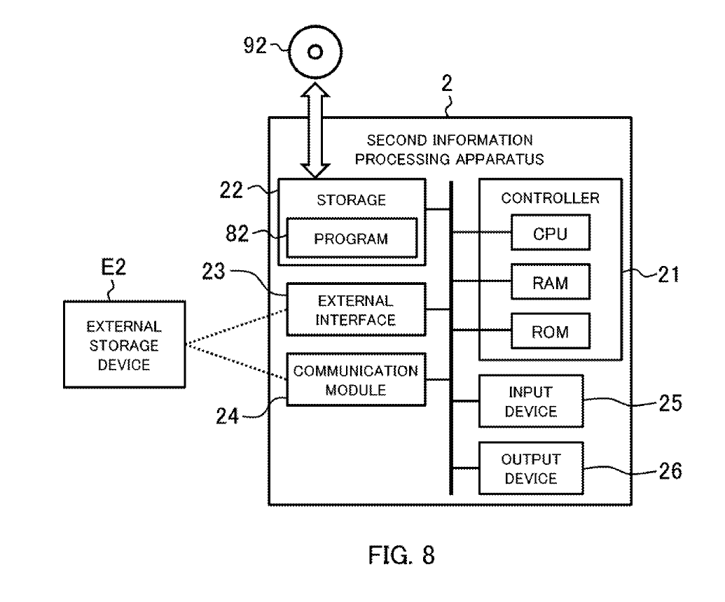

FIG. 8 schematically illustrates an example of the hardware configuration of the second information processing apparatus 2 according to the present embodiment. For example, the second information processing apparatus 2 may be configured as a computer that includes a controller 21, a storage 22, an external interface 23, a communication module 24, an input device 25, and an output device 26, which are electrically coupled to each other.

The controller 21 to output device 26, and a storage medium 92 of the second information processing apparatus 2 may be respectively configured similarly to the controller 11 to the output device 16, and the storage medium 91 of the first information processing apparatus 1. In the case in which the first information processing apparatus 1 and the second information processing apparatus 2 are the same, the controller 21 to the output device 26, and the storage medium 92 may be the same as the controller 11 to the output device 16, and the storage medium 91, respectively.

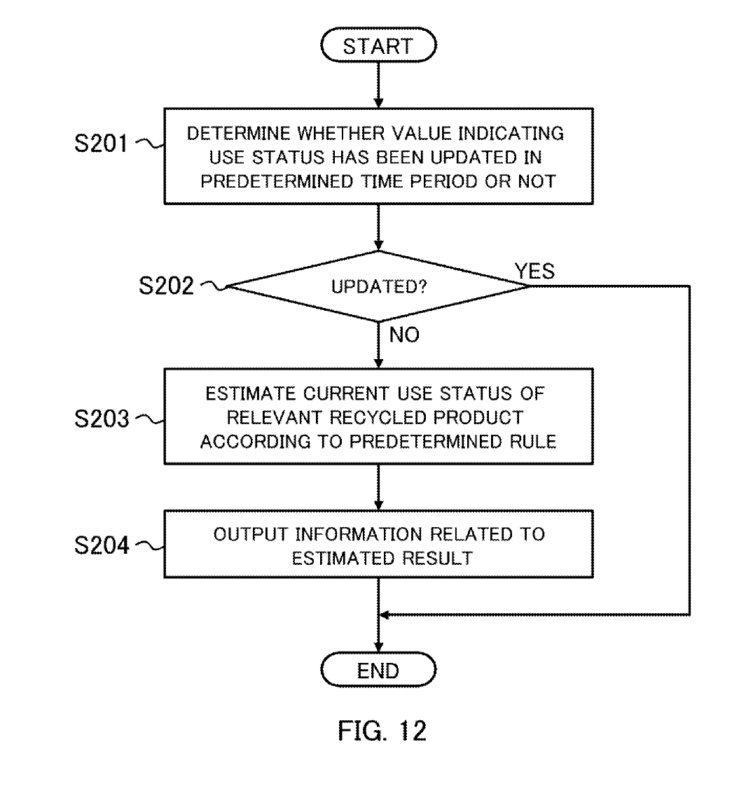

The controller 21 (CPU) is an example of the second controller in the present disclosure. The controller 21 (CPU) is an example of a processor resource of the second information processing apparatus 2. Each of the storage 22, the RAM, and the ROM is an example of the storage resource of the second information processing apparatus 2. For example, the storage 22 may store various types of information, such as the program 82. The program 82 is a program for causing the second information processing apparatus 2 to execute information processing (FIG. 12 described later) related to the estimation of the current use status. The program 82 includes a series of instructions of the information processing. The program 82 may be stored in the storage medium 92 instead of the storage 22 or along with the storage 22. Each of the storage 22 and the storage medium 92 is an example of a non-transitory storage medium. The second information processing apparatus 2 may obtain the program 82 from the storage medium 92. The storage medium 92 may include an external storage device that can be coupled to the second information processing apparatus 2. The second information processing apparatus 2 may be operated using the input device 25 and the output device 26.

For example, the first second information processing apparatus 2 may be coupled to the external storage device E2 via the external interface 23 or the communication module 24. The external storage device E2 may include a storage device of another computer, and an NAS. In the case in which the first information processing apparatus 1 may be made up of a computer different from the second information processing apparatus 2, the external storage device E2 may include the storage resource (the storage 12 or the like) of the first information processing apparatus 1. The storage resource M1 may be made up of at least one of the storage 22 and the external storage device E2. For example, in the case in which the storage resource M1 is made up of the storage 22, the controller 21 of the second information processing apparatus 2 may be configured to be accessible to the storage resource M1 by being coupled to the storage 22 via the bus. In the case in which the storage resource M1 is made up of the external storage device E2, the controller 21 of the second information processing apparatus 2 may be configured to be accessible to the storage resource M1 using the external interface 23 or the communication module 24.

Note that as for the specific hardware configuration of the second information processing apparatus 2, configuration elements may be omitted, replaced, and added as appropriate depending on the embodiment. For example, the controller 21 may include a plurality of hardware processors. The hardware processor may be made up of a microprocessor, an FPGA (Field-Programmable Gate Array), a DSP (Digital Signal Processor), an ECU (Electronic Control Unit), a GPU (Graphics Processing Unit), an ASIC (Application Specific Integrated Circuit), etc. At least one or some of the external interface 23, the communication module 24, the input device 25, and the output device 26 may be omitted. The program 82 may be stored in an external storage device, such as an NAS. The external storage device is also an example of a non-transitory storage medium. The second information processing apparatus 2 may be made up of a plurality of computers. In this case, the hardware configurations of the computers may be the same as or different from each other. The second information processing apparatus 2 may be not only a computer designed in a manner dedicated for a service to be provided, but also a general-purpose server apparatus, a general-purpose PC or the like.

### Software Configuration of First Information Processing Apparatus

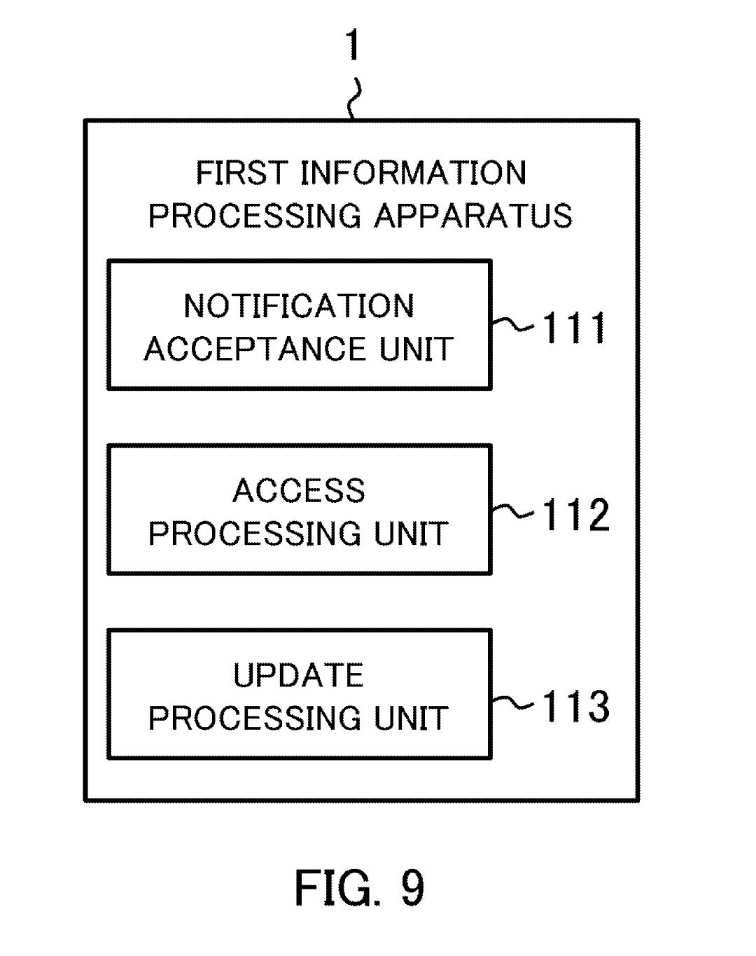

FIG. 9 schematically illustrates an example of the software configuration of the first information processing apparatus 1 according to the present embodiment. The controller 11 of the first information processing apparatus 1 causes the CPU to execute an instruction included in the program 81 stored in the storage 12. Accordingly, the first information processing apparatus 1 may operate as a computer that includes a notification acceptance unit 111, an access processing unit 112, and an update processing unit 113 as software modules. That is, in an example of the present embodiment, each software module of the first information processing apparatus 1 may be realized by the controller 11 (CPU).

The notification acceptance unit 111 is configured to receive the notification N1 that includes the identification information 40 on the target recycled product RP1 and is related to the use status of the target recycled product RP1, from the terminal T1 of the party concerned U1 of the target recycled product RP1. The access processing unit 112 accesses the product information 30 on the target recycled product RP1 in the product information 3 stored in the storage resource M1, using the identification information 40 included in the received notification N1. The update processing unit 113 updates the value 50 that indicates the use status and is included in the accessed product information 30 on the target recycled product RP1 in accordance with the received notification N1.

### Software Configuration of Second Information Processing Apparatus

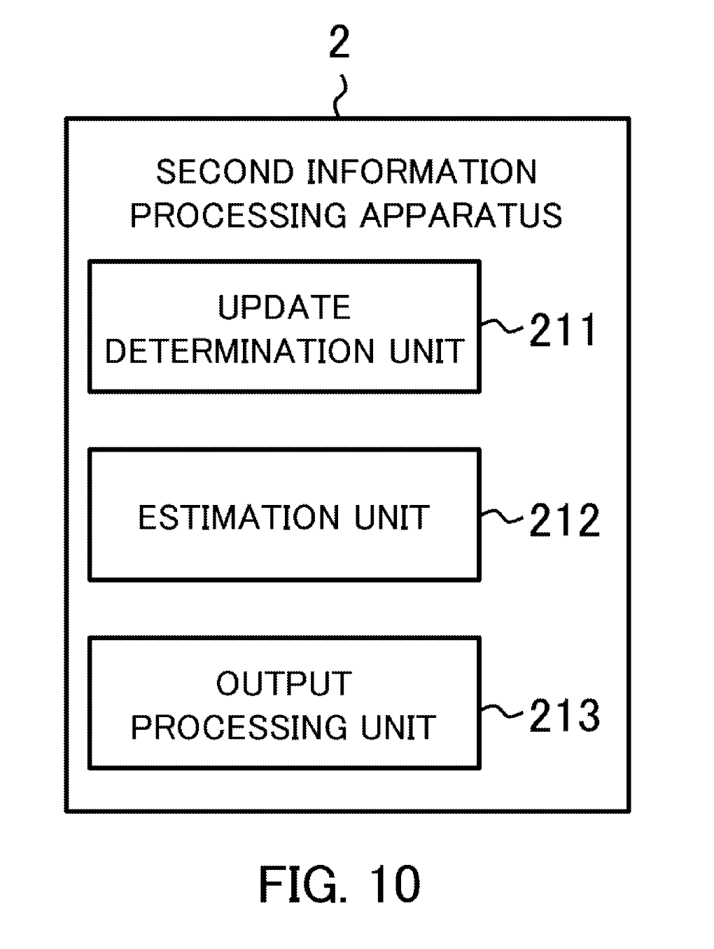

FIG. 10 schematically illustrates an example of the software configuration of the second information processing apparatus 2 according to the present embodiment. The controller 21 of the second information processing apparatus 2 causes the CPU to execute an instruction included in the program 82 stored in the storage 22. Accordingly, the second information processing apparatus 2 may operate as a computer that includes an update determination unit 211, an estimation unit 212, and an output processing unit 213 as software modules. That is, in an example of the present embodiment, each software module of the second information processing apparatus 2 may be realized by the controller 21 (CPU).

The update determination unit 211 is configured to determine, for each recycled product RP, whether the update of the value 5 indicating the use status in the product information 3 stored in the storage resource M1 is made in the predetermined time period or not. The estimation unit 212 is configured to estimate the current use status of the relevant recycled product RP5, from the value 55 indicating the use status of the relevant recycled product RP5 at the relevant time point at which the update is determined not to be made in the predetermined time period, according to the given rule PR, if the relevant recycled product RP5 that has not been updated in terms of the value indicating the value 5 (55) indicating the use status in the predetermined time period is present among the recycled products RP in the product information 3 stored in the storage resource M1. The output processing unit 213 is configured to output information related to the result 6 that is an estimate of the current use status of the relevant recycled product RP5.

### Other

Note that in an example of the present embodiment, all the software modules of the first information processing apparatus 1 and the second information processing apparatus 2 are realized by a general-purpose CPU. However, the method of realizing the modules described above is not limited to such an example, and may be changed as appropriate depending on the embodiment. Some or all of the software modules described above may be realized by one or more dedicated processors or chip sets. The modules described above may be realized as hardware modules. As for the software configurations of the first information processing apparatus 1 and the second information processing apparatus 2, modules may be omitted, replaced, and added as appropriate depending on the embodiment.

### 3 Operation Example

### Processing Procedures of First Information Processing Apparatus

FIG. 11 is a flowchart illustrating an example of processing procedures related to the update of the use status by the first information processing apparatus 1 according to the present embodiment. The processing procedure described below is an example of an information processing method executed by the computer. Note that the following processing procedure is only an example. Each step may be changed if feasible. The following processing procedures may be subjected to omission, replacement, and addition of steps as appropriate depending on the embodiment.

### Step S101

In step S101, the controller 11 operates as the notification acceptance unit 111, and receives the notification N1 related to the use status of the target recycled product RP1, from the terminal T1 of the party concerned U1 of the target recycled product RP1. The notification N1 includes the identification information 40 on the target recycled product RP1.

For example, the relevant recycled product RP1 (recycled product RP) may be the target battery BP1 (battery BP) mounted on the product MV. For example, the product MV may be a vehicle. For example, the types of the use status may include in-use and out-of-use. For example, out-of-use may include at least any of on-secondhand-sale, disposal-registered, collected, in-recycling, and recycled. Upon receipt of the notification N1, the controller 11 advances the processing to the next step S102.

### Step S102

In step S102, the controller 11 operates as the access processing unit 112, and accesses the product information 30 on the target recycled product RP1 in the product information 3 stored in the storage resource M1, using the identification information 40 included in the received notification N1. The access method may be freely selected. For example, the controller 11 may use the identification information 40 included in the notification N1 as a query, and search for the product information 30 in the product information 3 stored in the storage resource M1. The controller 11 may thus extract the product information 30. When the product information 30 is accessed, the controller 11 advances the processing to the next step S103.

### Step S103

In step S103, the controller 11 operates as the update processing unit 113, and updates the value 50 that indicates the use status and is included in the accessed product information 30 on the target recycled product RP1 in accordance with the received notification N1. For example, in the case in which the notification N1 directly includes the value indicating the latest use status, the controller 11 may update the value 50 indicating the use status by replacing the value 50 that indicates the use status and is included in the product information 30, with the value included in the notification N1. In another example, the notification N1 may be configured to indirectly include the value indicating the latest use status. The controller 11 may appropriately identify the latest use status, from information included in the notification N1. The controller 11 may update the value 50 indicating the use status by replacing the value 50 that indicates the use status and is included in the product information 30, with an identified value.

Upon completion of the update of the product information 30, the controller 11 finishes the processing procedures related to the update of the use status according to the present operation example. For example, in response to arrival of the notification N1 from the terminal T1, the controller 11 may execute the process in steps S101 to S103 may be executed at real time.

### Processing Procedures of Second Information Processing Apparatus

FIG. 12 is a flowchart illustrating an example of processing procedures related to estimation of the current use status by the second information processing apparatus 2 according to the present embodiment. The processing procedure described below is also an example of an information processing method executed by the computer. Note that the following processing procedure is only an example. Each step may be changed if feasible. The following processing procedures may be subjected to omission, replacement, and addition of steps as appropriate depending on the embodiment.

### Step S201 and Step S202

In step S201, the controller 21 operates as the update determination unit 211, and determines, for each recycled product RP, whether the update of the value 5 indicating the use status in the product information 3 stored in the storage resource M1 is made in the predetermined time period or not.

The determination process may be configured as appropriate depending on the embodiment. For example, the controller 21 may calculate the elapsed time period since the update, from the difference between the time at the determination (current time) and the update date and time of the use status included in the product information 3. The controller 21 may determine whether the update of the value 5 indicating the use status is performed in the predetermined time period or not depending on whether the calculated elapsed time period exceeds the predetermined time period or not. In response to the fact that the calculated elapsed time period exceeds the predetermined time period, the controller 21 may determine that the update of the value 5 indicating the use status is not performed in the predetermined time period. On the other hand, in response to the fact that the calculated elapsed time period is less than the predetermined time period, the controller 21 may determine that the update of the value 5 indicating the use status is performed in the predetermined time period. If the calculated elapsed time period is equal to the predetermined time period, the controller 21 may determine that the update of the value 5 indicating the use status is performed in the predetermined time period or not.

In step S202, the controller 21 determines the branch destination of the processing depending on the determination result in step S201. If there is a relevant recycled product RP5 having the value 5 (55) that indicates the use status and has not been updated in the predetermined time period among the recycled products RP, the controller 21 advances the processing to the next step S203. On the other hand, if there is not any relevant recycled product RP5, the controller 21 omits the processes in the next steps S203 and S204, and finishes the processing procedures related to the estimation of the current use status according to the present operation example.

### Step S203

In step S203, the controller 21 estimates the current use status of the relevant recycled product RP5, from the value 55 indicating the use status of the relevant recycled product RP5 at the relevant time point at which the update was determined not to be performed in the predetermined time period, according to the given rule PR.

For example, the types of the use status may include in-use and out-of-use. In response to the fact that the value 55 indicating the use status has not been updated in the predetermined time period and the use status indicated by the value 55 is out-of-use, the controller 21 may estimate that there is a probability that the relevant recycled product RP5 has been smuggled abroad or misused domestically.

For example, the recycled product RP may be the battery BP mounted on the product MV, and out-of-use may include on-secondhand-sale. In accordance with this, in response to the fact that the value 55 indicating the use status has not been updated in the predetermined time period and the use status indicated by the value 55 is on-secondhand-sale, the controller 21 may estimate that there is a probability that the relevant battery BP5 has been smuggled abroad or misused domestically in the state of being mounted on the product MV.

For example, the recycled product RP may be the battery BP mounted on the product MV, and out-of-use may include disposal-registered or collected. In accordance with this, in response to the fact that the value 55 indicating the use status has not been updated in the predetermined time period and the use status indicated by the value 55 is disposal-registered or collected, the controller 21 may estimate that there is a probability that the relevant battery BP5 has been smuggled abroad or misused domestically after removal from the product MV.

For example, out-of-use may include in-recycling. In accordance with this, in response to the fact that the value 55 indicating the use status has not been updated in the predetermined time period and the use status indicated by the value 55 is in-recycling, the controller 21 may estimate that there is a probability that the relevant recycled product RP5 has been recycled into a recycled material and then smuggled abroad or misused domestically. For example, in the case in which the recycled product RP is the battery BP mounted on the product MV, the recycled material may be black mass.

Note that the given rule PR may be appropriately provided for a use status other than that described above depending on the embodiment. The types of the use status may include a type provided with no given rule PR. In the case in which the value 55 indicates this type, the controller 21 may omit the process of estimating the current use status with respect to the relevant recycled product RP5 as the target. After estimation of the current use status of the relevant recycled product RP5, the controller 21 advances the processing to the next step S204.

### Step S204

In step S204, the controller 21 outputs information related to the result 6 that is an estimate of the current use status of the relevant recycled product RP5.

The output destination and the content of information to be output may be selected as appropriate depending on the embodiment. For example, the controller 21 may output, as it is, the obtained estimated result 6. The output destination may be, for example, the RAM, the storage 22, the output device 26, another computer, the external storage device (including the external storage device E2), etc. For example, the controller 21 may write the result 6 in the estimation result field of the product information 35 on the relevant recycled product RP5. Accordingly, any viewer can grasp the estimated current use status of the recycled product RP (relevant recycled product RP5) by referring to the product information 3 (35).

For example, the controller 21 may execute any piece of information processing in accordance with the estimated result 6. The controller 21 may output the result of the execution of the information processing, as information related to the estimated result 6. The output of the result of the execution of the information processing may include, for example, outputting a specific message in accordance with the estimated result 6. The output destination may be, for example, the RAM, the storage 22, the output device 26, another computer, the external storage device, etc.

For example, if it is estimated that there is a probability that the relevant recycled product RP5 has been smuggled abroad or misused domestically, the controller 21 may transmit a notification for notifying any target party's terminal of the probability. The target party may be, for example, the seller, the party concerned or the like. The party concerned may be the owner, such as the user. Transmitting the notification may prompt the party concerned to update the use status. The transmission destination of the notification may be identified by, for example, an email address, an account, a phone number, a terminal ID or the like. The information on the transmission destination may be held in the storage resource of the second information processing apparatus 2, or be held in an external storage resource to which the second information processing apparatus 2 is accessible. The controller 21 may refer to the information on the transmission destination as appropriate.

In the case in which the given rule PR is defined such that the longer the elapsed time period without any update is, the higher the estimated certainty of the current use status is, the form of notification (degree of importance etc.) may be selected depending on the estimated certainty. The controller 21 may transmit the notification about the selected form to the target party. For example, in the aforementioned case in which the predetermined time period includes the first predetermined time period and the second predetermined time period, if the elapsed time period since the update exceeds the first predetermined time period but does not exceed the second predetermined time period, the controller 21 may transmit, to the target party, a notification made up of a reminder for indicating that there is a probability of smuggling abroad or domestic misuse. If the elapsed time period since the update exceeds both the first predetermined time period and the second predetermined time period, the controller 21 may transmit a notification made up of a warning for indicating that the probability of smuggling abroad or domestic misuse is high.

Upon completion of outputting the information related to the estimated result 6, the controller 21 finishes the processing procedures related to the estimation of the current use status according to the present operation example. The controller 21 may repetitively execute the processes in steps S201 to S204. For example, the controller 21 may periodically execute the processes in steps S201 to S204. The cycle of repeating the processes in steps S201 to S204 may be freely defined.

### Characteristics

In the present embodiment, according to the processes in steps S101 to S103, based on the notification N1 from the terminal T1 of the party concerned U1, the traceability of the use status during authorized operation after the distribution of the recycled product RP can be ensured. In addition, according to the processes in steps S201 to S204, the current use status of the recycled product RP after the halt of the update of the use status can be traced at a certain certainty, based on monitoring of whether the use status is updated in the predetermined time period or not. Consequently, according to the present embodiment, it can be expected that the traceability is appropriately ensured after the distribution of the recycled product RP.

### 4 Modified Example

The embodiment of the present disclosure has been described above in detail. However, the aforementioned description are only examples of the present disclosure in all respects. The processes and means described in the present disclosure may be freely combined and implemented unless any technical contradiction occurs. The embodiment described above may be variously improved or changed as appropriate. The processes and means described in the present disclosure may be freely combined and implemented unless any technical contradiction occurs.

The process described to be performed by one apparatus may be executed by a plurality of apparatuses in a shared manner. Alternatively, the processes described to be performed by different apparatuses may be executed by a single apparatus. In the computer system, it can be flexibly changed what hardware configuration achieves each function.

The present disclosure can be achieved also by providing a computer with a computer program where the functions described in the aforementioned embodiment are implemented, and causing one or more processors included in the computer to read and execute the program. Such a computer program may be provided for the computer through a non-transitory computer-readable storage medium connectable to a system bus of the computer, or provided for the computer via a network. The non-transitory computer-readable storage medium may be, for example, a disk of any type, a read-only memory (ROM), a random access memory (RAM), an EPROM, an EEPROM, a magnetic card, a flash memory, an optical card, a semiconductor drive, a medium of any type suitable for storing electronic instructions or the like. The disk may be, for example, a magnetic disk, an optical disk or the like. The magnetic disk may be, for example, a hard disk drive (HDD) or the like. The optical disk may be, for example, a CD-ROM, a DVD disk, a Blu-ray Disc or the like. The semiconductor drive may be, for example, a solid-state drive or the like.

What is claimed is:

1. An information processing system, comprising: a first information processing apparatus; a second information processing apparatus; and a storage resource, wherein
the first information processing apparatus includes a first controller, and is configured to be accessible to the storage resource,
the second information processing apparatus includes a second controller, and is configured to be accessible to the storage resource,
the storage resource stores, for each vehicle battery, battery information that includes identification information and a value indicating a use status of a vehicle battery,
the first controller of the first information processing apparatus is configured to execute:
receiving, from a vehicle terminal in real time, a notification that includes the identification information on the target vehicle battery and is related to the use status of the target vehicle battery;
accessing the battery information on the target vehicle battery in the battery information stored in the storage resource using the identification information included in the received notification; and
updating the value indicating the use status included in the accessed battery information on the target vehicle battery, in accordance with the received notification,
the second controller of the second information processing apparatus is configured to execute:
determining, for each vehicle battery, whether an update of the value indicating the use status in the battery information stored in the storage resource is made in a predetermined time period or not;
estimating a current use status of a relevant vehicle battery that has not been updated in terms of the value indicating the use status in the predetermined time period, from the value indicating the use status of the relevant vehicle battery at a relevant time point at which the update is determined not to be made in the predetermined time period, according to a given rule, when the relevant vehicle battery is present among the vehicle batteries; and
outputting information related to a result of an estimation of the current use status of the relevant vehicle battery in real time.

2. An information processing system, comprising: a first information processing apparatus; a second information processing apparatus; and a storage resource, wherein
the first information processing apparatus includes a first controller, and is configured to be accessible to the storage resource,
the second information processing apparatus includes a second controller, and is configured to be accessible to the storage resource,
the storage resource stores, for each recycled product, product information that includes identification information and a value indicating a use status of a recycled product,
the first controller of the first information processing apparatus is configured to execute:
receiving, from a terminal of a party concerned of a target recycled product, a notification that includes the identification information on the target recycled product, and is related to the use status of the target recycled product;
accessing the product information on the target recycled product in the product information stored in the storage resource using the identification information included in the received notification; and
updating the value indicating the use status included in the accessed product information on the target recycled product, in accordance with the received notification,
the second controller of the second information processing apparatus is configured to execute:
determining, for each recycle product, whether an update of the value indicating the use status in the product information stored in the storage resource is made in a predetermined time period or not;
estimating a current use status of a relevant recycled product that has not been updated in terms of the value indicating the use status in the predetermined time period, from the value indicating the use status of the relevant recycled product at a relevant time point at which the update is determined not to be made in the predetermined time period, according to a given rule, when the relevant recycled product is present among the recycled products; and
outputting information related to a result of an estimation of the current use status of the relevant recycled product.

3. The information processing system according to claim 2, wherein
the recycled product is a battery mounted on a product.

4. The information processing system according to claim 3, wherein
the product is a vehicle.

5. The information processing system according to claim 2, wherein
types of the use status include in-use and out-of-use, and
an estimation of the current use status of the relevant recycled product includes estimating that there is a probability that the relevant recycled product has been smuggled abroad or misused domestically, as the current use status, when the value indicating the use status of the relevant recycled product at the relevant time point is out-of-use.

6. The information processing system according to claim 2, wherein
the recycled product is a battery mounted on a product,
types of the use status include in-use and out-of-use,
the out-of-use includes on-secondhand-sale, and
an estimation of the current use status of the relevant recycled product includes estimating that there is a probability that a relevant battery has been smuggled abroad or misused domestically in a state of being mounted on the product, as the current use status, when the value indicating the use status of the relevant battery at the relevant time point is on-secondhand-sale.

7. The information processing system according to claim 2, wherein
the recycled product is a battery mounted on a product,
types of the use status include in-use and out-of-use,
the out-of-use includes disposal-registered or collected, and
an estimation of the current use status of the relevant recycled product includes estimating that there is a probability that the relevant battery has been smuggled abroad or misused domestically after removal from the product, as the current use status, when the value indicating the use status of the relevant battery at the relevant time point is disposal-registered or collected.

8. The information processing system according to claim 2, wherein
types of the use status include in-use and out-of-use, and
the out-of-use includes in-recycling, and
an estimation of the current use status of the relevant recycled product includes estimating that there is a probability that the relevant recycled product has been recycled into a recycled material and then smuggled abroad or misused domestically, with respect to the current use status, when the value indicating the use status of the relevant recycled product at the relevant time point is in-recycling.

9. The information processing system according to claim 8, wherein
the recycled product is a battery mounted on a product,
the recycled material is black mass.

10. An information processing method executed by a first computer and a second computer that are configured to be accessible to a storage resource that stores, for each recycle product, product information that includes identification information and a value indicating a use status of a recycled product, the method comprising:
the first computer receiving, from a terminal of a party concerned of a target recycled product, a notification that includes the identification information on the target recycled product, and is related to the use status of the target recycled product;
the first computer accessing the product information on the target recycled product in the product information stored in the storage resource using the identification information included in the received notification; and
the first computer updating the value indicating the use status included in the accessed product information on the target recycled product, in accordance with the received notification,
the second computer determining, for each recycled product, whether an update of the value indicating the use status in the product information stored in the storage resource is made in a predetermined time period or not;
the second computer estimating a current use status of a relevant recycled product that has not been updated in terms of the value indicating the use status in the predetermined time period, from the value indicating the use status of the relevant recycled product at a relevant time point at which the update is determined not to be made in the predetermined time period, according to a given rule, when the relevant recycled product is present among the recycled products; and
the second computer outputting information related to a result of an estimation of the current use status of the relevant recycled product.

11. The information processing method according to claim 10, wherein
the recycled product is a battery mounted on a product.

12. The information processing method according to claim 11, wherein
the product is a vehicle.

13. The information processing method according to claim 10, wherein
types of the use status include in-use and out-of-use, and
an estimation of the current use status of the relevant recycled product includes estimating that there is a probability that the relevant recycled product has been smuggled abroad or misused domestically, as the current use status, when the value indicating the use status of the relevant recycled product at the relevant time point is out-of-use.

14. The information processing method according to claim 10, wherein
the recycled product is a battery mounted on a product,
types of the use status include in-use and out-of-use,
the out-of-use includes on-secondhand-sale, and
an estimation of the current use status of the relevant recycled product includes estimating that there is a probability that a relevant battery has been smuggled abroad or misused domestically in a state of being mounted on the product, as the current use status, when the value indicating the use status of the relevant battery at the relevant time point is on-secondhand-sale.

15. The information processing method according to claim 10, wherein
the recycled product is a battery mounted on a product,
types of the use status include in-use and out-of-use,
the out-of-use includes disposal-registered or collected, and
an estimation of the current use status of the relevant recycled product includes estimating that there is a probability that the relevant battery has been smuggled abroad or misused domestically after removal from the product, as the current use status, when the value indicating the use status of the relevant battery at the relevant time point is disposal-registered or collected.

16. The information processing method according to claim 10, wherein
types of the use status include in-use and out-of-use,
the out-of-use includes in-recycling, and
an estimation of the current use status of the relevant recycled product includes estimating that there is a probability that the relevant recycled product has been recycled into a recycled material and then smuggled abroad or misused domestically, with respect to the current use status, when the value indicating the use status of the relevant recycled product at the relevant time point is in-recycling.

17. The information processing method according to claim 16, wherein
the recycled product is a battery mounted on a product, and
the recycled material is black mass.
